(19) United States
(12) Patent Application Publication
(10) Pub. No.: US 2017/0169025 A1
(43) Pub. Date: Jun. 15, 2017

(54) Estimating Geographic Entity Capacity

(71) Applicant: Google Inc., Mountain View, CA (US)

(72) Inventors: Alexander Fabrikant, Menlo Park, CA (US); Chris Riederer, New York, NY (US); James Alexander Cook, Mountain View, CA (US); Shanmugasundaram Ravikumar, Berkeley, CA (US)

(21) Appl. No.: 14/968,308

(22) Filed: Dec. 14, 2015

(51) Int. Cl. G06F 17/30

(52) U.S. Cl. CPC G06F 17/3053; G06F 17/30241; G06F 17/30528; G06F 17/30554; G06F 17/30867

(57) ABSTRACT

Systems and methods for ascertaining capacities of location entities. A plurality of location reports can be obtained from one or more user device. Each of the plurality of location reports can include at least a set of data indicative of an associated location and time. A number of user devices associated with the location entity can be determined. A capacity of the location entity can be estimated based, at least in part, on the number of user devices associated with the location entity.

### FIELD

The present disclosure relates generally to systems and methods for estimating the capacity of a location entity. In particular, the present disclosure is directed to systems and methods for analyzing location reports received from one or more devices associated with a user to determine the capacity of a location entity.

### BACKGROUND

Knowledge of a capacity of a “point of interest” (e.g., restaurant, event venue, parking lot) can be important for social event planning, urban planning and development, as well as government permitting. Individuals can determine whether a particular point of interest is suitable for an event or whether to patronize a particular point of interest based upon the capacity. Moreover, local governments can determine whether to approve the issuance of new permits or to review previously issued permits based on capacity. Curating rich, updated, high-coverage geospatial databases of points of interest is difficult at large scale. The resources necessary to create and maintain such a database can be costly and complex. Further, large scale geospatial databases can be prohibitively expensive, as well as involve error- and spam-prone crowdsourcing.

### SUMMARY

Aspects and advantages of the present disclosure will be set forth in part in the following description, or can be obvious from the description, or can be learned through practice of embodiments of the present disclosure.

One example aspect of the present disclosure is directed to a computer-implemented method of ascertaining capacities of location entities. The method includes obtaining, by one or more computing devices, a plurality of location reports from one or more user devices. Each of the plurality of location reports can include at least a set of data indicative of an associated location and time. The method also includes determining, by the one or more computing devices, whether the one or more user devices are associated with a location entity based at least in part on the set of data of the plurality of location reports. The method includes determining, by the one or more computing devices, one or more sets of data associated with the location entity at one or more times. Each of the sets of data can be indicative of at least a number of the one or more user devices associated with the location entity at the respective time. The method also includes estimating, by the one or more computing devices, a capacity of the location entity based at least in part on the one or more values associated with the location entity at the one or more times.

Another example aspect of the present disclosure is directed to a computer system. The computer system includes one or more processors and one or more memory devices. The one or more memory devices can store computer-readable instructions that when executed by the one or more processors, cause the one or more processors to perform operations. The operations include obtaining a plurality of location reports from one or more user devices. Each of the plurality of location reports can indicate an associated location and time. The operations also include determining whether the one or more user devices are associated with a location entity based at least in part on the plurality of location reports. The operations include estimating a capacity of the location entity based at least in part on a number of the one or more user devices associated with the location entity.

Yet another example aspect of the present disclosure is directed to a computer system that includes one or more processors and one or more memory devices. The one or more memory devices can store computer-readable instructions that when executed by the one or more processors, cause the one or more processors to perform operations. The operations include obtaining a plurality of location reports respectively indicating a location and a time, the plurality of location reports being associated with a plurality of user devices. The operations also include determining a location entity associated with the location indicated in each of the plurality of location reports. The operations include determining a number of the plurality of user devices that are located at the location entity within one or more time periods. The operations also include estimating a capacity of the location entity based at least in part on the number of the plurality of user devices that are determined to be located at the location entity within the one or more time periods.

These and other features, aspects and advantages of the present disclosure will become better understood with reference to the following description and appended claims. The accompanying drawings, which are incorporated in and constitute a part of this specification, illustrate embodiments of the present disclosure and, together with the description, serve to explain the principles of the present disclosure.

### BRIEF DESCRIPTION OF THE DRAWINGS

A full and enabling description of the present disclosure, directed to one of ordinary skill in the art, is set forth in the specification, which makes reference to the appended figures, in which:

FIG. 1 depicts an example system according to example embodiments of the present disclosure;

FIG. 2 depicts an example graphical representation of a plurality of location reports according to example embodiments of the present disclosure;

FIG. 3 depicts a flow chart of an example method for determining user device location according to example embodiments of the present disclosure;

FIG. 4 depicts a flow chart of an example method for estimating location entity capacity according to example embodiments of the present disclosure;

FIG. 5 depicts a flow chart of an example method for determining the occurrence of a turnaround according to example embodiments of the present disclosure; and

FIG. 6 depicts an example system according to example embodiments of the present disclosure.

### DETAILED DESCRIPTION

Reference now will be made in detail to embodiments of the present disclosure, one or more examples of which are illustrated in the drawings. Each example is provided by way of explanation of the present disclosure, not limitation of the present disclosure. In fact, it will be apparent to those skilled in the art that various modifications and variations can be made to the present disclosure without departing from the scope or spirit of the disclosure. For instance, features illustrated or described as part of one embodiment can be used with another embodiment to yield a still further embodiment. Thus, it is intended that the present disclosure covers such modifications and variations as come within the scope of the appended claims and their equivalents.

Example aspects of the present disclosure are directed to determining the capacity of a location entity. The systems and methods of the present disclosure can estimate the capacity of a location entity based upon location information received from one or more user devices associated with a user. For instance, the systems and methods can analyze location reports sent by the one or more user devices to identify that a user device is located at a real world location entity (e.g., restaurant, parking lot, event venue, or other points of interest). The systems and methods can determine the number of user devices located at the location entity and estimate the capacity of the location entity. The capacity can be, for example, the maximum number of patrons allowed or otherwise commonly accommodated in a location entity. The capacity can be stored and later provided to one or more user devices to allow a user to learn the estimated capacity of a location entity.

More particularly, one or more user devices can periodically provide a raw location report to one or more servers implementing the present disclosure. Each location report can provide a time and a location associated with the user device. For example, the location included in each location report can be a geocode (e.g. latitude and longitude), IP address information, WiFi location information, or other information identifying or associated with a particular location.

Furthermore, in some embodiments, a user may not receive the benefits or be included in the techniques described herein unless they select a setting and/or install one or more applications, drivers, etc. In some embodiments, certain data can be treated in one or more ways before it is stored or used, so that user information and/or geographic information is removed.

According to an aspect of the present disclosure, the systems and methods described herein can estimate the capacity of a location entity by analyzing the plurality of location reports. For instance, the plurality of location reports can be clustered into a plurality of segments. In some example implementations, the plurality of location reports can be clustered based on location or time. If a number of location reports are received that provide the same general location over a significant period of time, then such reports can be clustered together to form a segment and the segment can be further analyzed to identify an associated location entity. In this way, the systems and methods can determine whether a user device is associated with a location entity (e.g., whether a user was previously and/or is currently located at a location entity) and, accordingly, determine a number of user devices associated with the location entity within one or more time periods.

Based, at least in part, on the number of user devices associated with the location entity, the systems and methods of the present disclosure can estimate the capacity of the location entity. For instance, one or more parameters of a binomial distribution can be generated based at least in part on the number of user devices located at the location entity within each of the one or more time periods. The systems and methods can estimate the capacity of the location by adjusting the parameters of the binomial distribution to determine a best fit. Additionally, and/or alternatively, the systems and methods can utilize a Markov model, maximum likelihood estimate, and/or other statistical approaches for estimating capacity.

The systems and methods can also determine the occurrence of a “turnaround” to help estimate the capacity of a location entity. A turnaround can occur, for example, when the user arrives at or within a proximity of a location entity that the user intends to patronize, but leaves without becoming a patron. As one example, a user can visit a restaurant that she intends to patronize, but leave when she realizes that the restaurant is at capacity and she will be required to wait an undesirable amount of time to be served.

The occurrence of a turnaround can indicate that the location entity is at capacity. Thus, the systems and methods can recognize user behavior as a “turnaround” and leverage detection of such turnaround as a signal regarding the current capacity status of the restaurant. In particular, the systems and method described herein can determine the number of user devices associated with the location entity during a time period in which a turnaround occurs and can estimate the capacity of the location entity based, at least in part, on that number of user devices. Thus, in some implementations, particular scrutiny can be applied to the number of user devices associated with the location entity (e.g., located at the location entity) during time periods in which turnarounds occur.

According to another aspect of the present disclosure, in some implementations, the systems and methods can determine whether a user intends to patronize a location entity based on one or more features associated with the location entity. For instance, the one or more features can indicate the user's interest in the location entity by including, for example, a number of instances in which the user performed a map click with respect to the location entity, a number of instances in which the user has previously checked-in to the location entity, and/or a number of instances in which the user has performed a web search query with respect to the location entity. Additionally, and/or alternatively, the one or more features can indicate the popularity of the location entity by including, for example, a number of social media mentions associated with the location entity. Features which indicate that a user intended to patronize a particular location entity, but ultimately did not do so, can be used as a strong signal that a turnaround occurred.

Alternatively or in addition to the above described features, the systems and methods of the present disclosure can determine the occurrence of a turnaround by analyzing the location reports sent by a user device. In particular, in some example implementations, the plurality of location reports can include a first location report that includes a first location and a first time and a second location report that includes a second location and a second time. The systems and methods can determine that a user device is within a proximity of the location entity based at least in part on the first location included in the first location report. The systems and methods can then determine that the user device has left the proximity of the location entity based at least in part on the second location, which can be different than the first location.

Moreover, the systems and methods can determine a time difference between the first time (associated with the first location) and the second time (associated with the second location) and compare the time difference to a time threshold. The time threshold can, for example, represent the average minimum time a patron typically spends at the location entity, a typical time for attending an event at the location (e.g., concert, sporting event, theatrical play, etc.), or other times associated with typical patrons of the location entity. The systems and methods can determine the occurrence of a turnaround based, at least in part, on the time difference being less than the time threshold.

In other example implementations, the systems and methods can determine the occurrence of a turnaround based on the location of the user device and potential interest in an alternative location. For instance, the systems and methods can determine that the first user device is within a proximity of the location entity based, at least in part, on the first location. The systems and methods can determine one or more features associated with an alternative location entity, where the features associated with the alternative location entity indicate an interest level associated with the alternative location entity. Such features can include, for example, a number of instances in which the user has performed a web search query with respect to the alternative location entity. The systems and methods can then determine that the first user device is not within a proximity of the location entity based at least in part on the second location. Accordingly, the systems and methods can determine the occurrence of a turnaround based, at least in part, on the features associated with the alternative location entity (indicating the user's interest in the alternative location entity) and the second location included in the second location report (indicating that the user has left the proximity of the location entity).

In some implementations, a turnaround can be particularly indicated when the alternative location entity is of a similar character to the original location entity. For example, if the user searches for an alternative breakfast restaurant after arriving at the original breakfast restaurant, this can be viewed as a more significant indicator of a turnaround than if the user searched for an outdoor sports equipment shop after arriving at the original breakfast restaurant. Thus, in some implementations, a degree of relatedness or fungibility between the original and alternative location entities can impact the detection of a turnaround.

Thus, the occurrence of a turnaround can help the systems and methods to determine specific times at which the location entity may be at capacity. Data collected at such times (e.g., data that indicates a number of user devices located at the location entity at such time) can be particularly analyzed to assist in determining the capacity of the location entity.

Determining the capacity of a location entity according to example aspects of the present disclosure represents acquisition of an additional useful data point regarding a point-of-interest or location entity. For example, knowledge of capacity of a particular location entity can be useful for coordinating social events, urban planning, as well as issuing government permits. Moreover, the systems and methods of the present disclosure can help reduce the need for and reliance on large, expensive, and error-prone geographic databases and further reduce the need for inefficient manual collection of data.

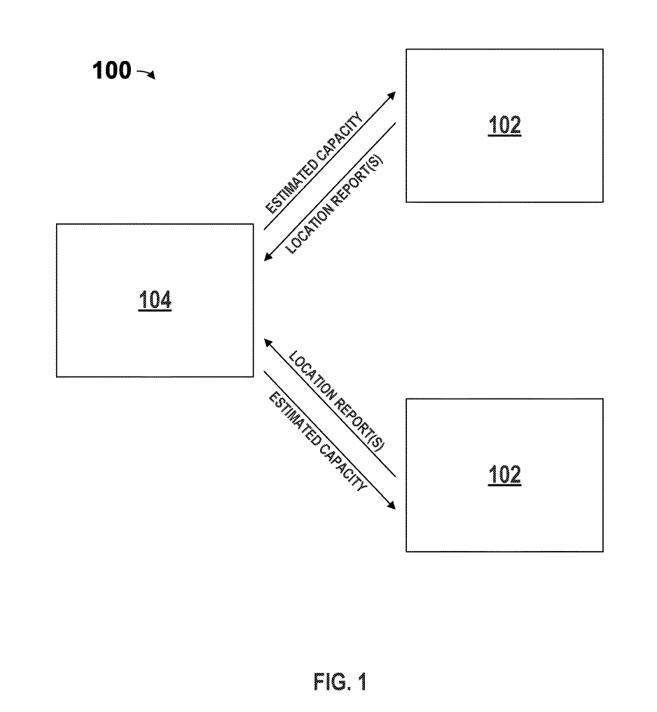

With reference now to the FIGS., example embodiments of the present disclosure will be discussed in further detail. FIG. 1 depicts an example system 100 for determining location entity capacity according to example embodiments of the present disclosure. As used herein, a location entity refers to any point of interest, or other object or event associated with a geographic location. For instance, a location entity can include a business, restaurant, parking facility, retail outlet, coffee shop, bar, music venue, attraction, museum, theme park, arena, stadium, festival, organization, entity, or other suitable points of interest. Each location entity can be designated by a semantic identifier (e.g. the common “name” of restaurant, store, etc.), as distinguished from a coordinate-based or location-based identifier. However, in addition to a name, the data associated with a particular location entity can further include the location of the location entity, such as longitude, latitude, and altitude coordinates associated with the location entity.

System 100 can include one or more user devices 102 and a capacity estimation system 104. In some implementations, user device 102 and capacity estimation system 104 can communicate with each other over a network. User device 102 can be associated with a user. By way of example, user device 102 can be a mobile device, personal communication device, a smartphone, navigation system, laptop computer, tablet, wearable computing device or the like. User device 102 can be configured to periodically provide a raw location report to capacity estimation system 104.

Each location report can provide a time and a location associated with user device 102. For example, the location included in each location report can be a geocode (e.g. latitude and longitude), IP address information, WiFi location information, or other information identifying or associated with a particular location. The location can be determined, at least in part, on a navigation system, global positioning system (GPS), Wi-Fi access points, cell towers, Bluetooth transmitters, and/or any other suitable location determining mechanism.

Capacity estimation system 104 can be implemented using one or more computing devices, such as, for example, one or more servers. Capacity estimation system 104 can be configured to obtain a plurality of location reports from one or more user devices. For instance, one or more user devices 102 can send one or more location reports to capacity estimation system 104 and capacity estimation system 104 can receive the one or more location reports. Each location report can include at least a set of data indicative of an associated location and time of the user device 102 at the time the location report was created and/or sent.

Capacity estimation system 104 can be configured to determine whether the one or more user devices 102 are associated with a location entity (e.g., was or is located at the location entity) based, at least in part, on the set of data of the location reports. For instance, capacity estimation system 104 can be configured to cluster the location reports into segments. In some implementations, the location reports can be clustered based on location and/or time. Capacity estimation system 104 can be configured to identify a plurality of candidate location entities for the segments. For instance, map data can be analyzed to identify all location entities that are within a threshold distance from a segment location associated with the segment.

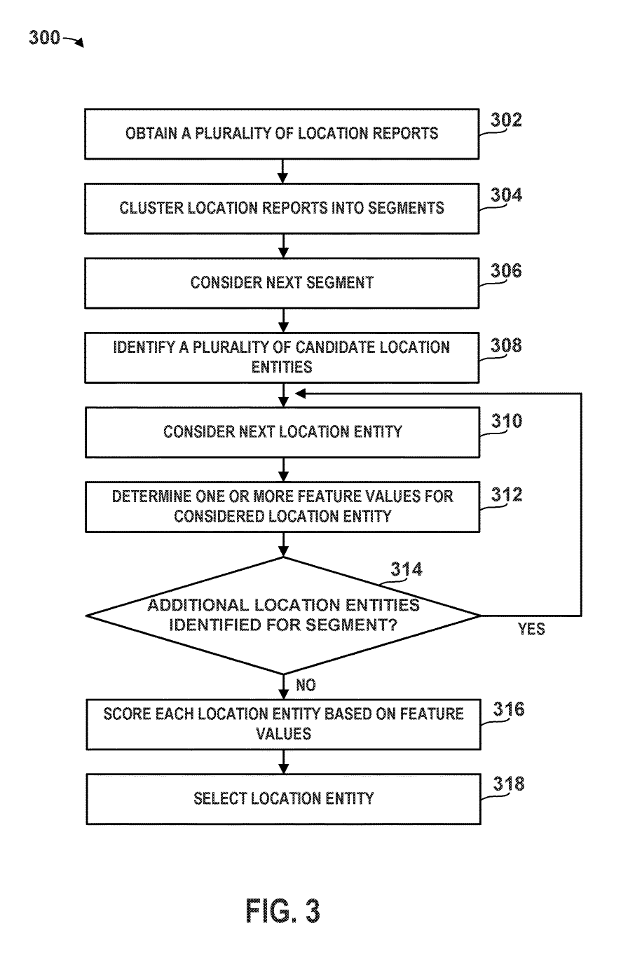

Moreover, capacity estimation system 104 can be configured to sort, order, and/or otherwise organize the candidate location entities and consider each candidate location entity on an individual basis. For instance, capacity estimation system 104 can be configured to determine one or more feature values for a location entity. The feature values can be based on one or more features associated with the location entity. In some implementations, the one or more features can include one or more of a feature indicative of a popularity of the location entity, a business hour overlap feature, a feature indicative of the user's interest in the location entity, and other features as further described herein with respect to FIGS. 3-5.

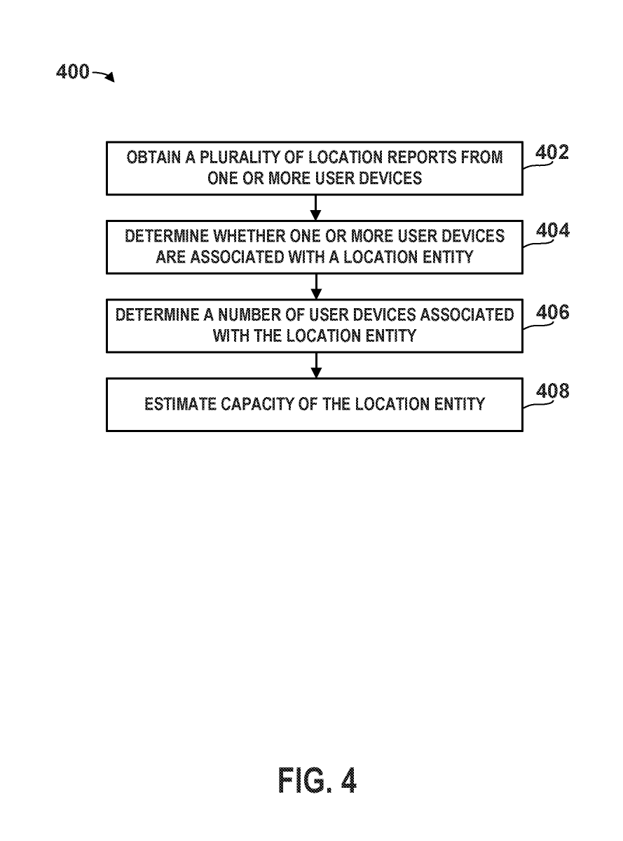

Capacity estimation system 104 can be configured to score each candidate location entity based, at least in part, upon the features values. The score can be based upon a scoring formula and/or compared to the scores of other candidate location entities, as further described herein with respect to FIG. 4. Capacity estimation system 104 can be configured to select a location entity as the location entity at which the user device 102 is located. For example, capacity estimation system 104 can be configured to select the highest-scoring candidate location entity as the location entity at which the user device 102 is located.

Capacity estimation system 104 can be configured to determine a number of user devices that are associated with the location entity within one or more time periods. For instance, capacity estimation system can perform the method (300), described herein, for each of a plurality of user devices to determine how many user devices are located at a particular location entity.

Moreover, capacity estimation system 104 can be configured to estimate the capacity of the location entity. The estimate can be based, at least in part, on the number of the one or more user devices 102 that are determined to be associated with the location entity. For example, capacity estimation system 104 can be configured to estimate the capacity by utilizing a binomial distribution, Markov model, maximum likelihood estimate, and/or other statistical approaches, as further described herein.

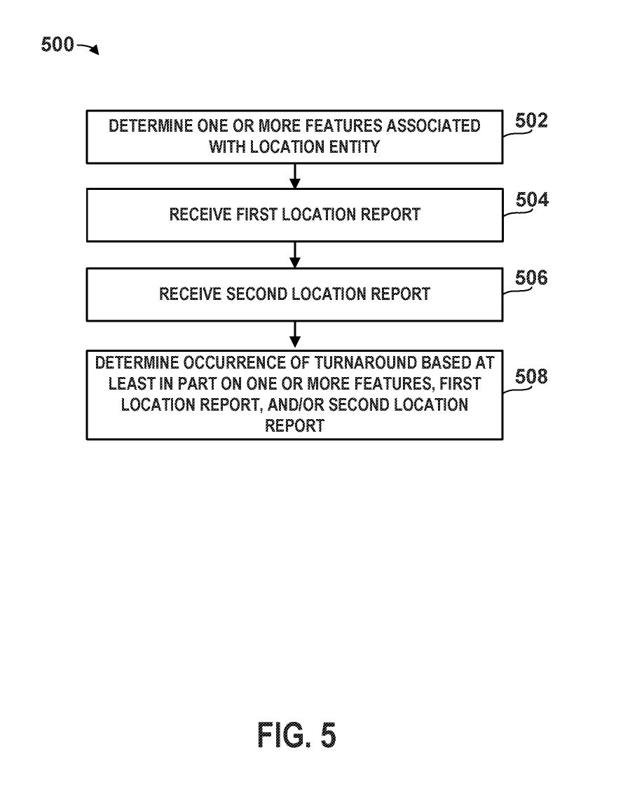

Additionally, or alternatively, capacity estimation system 104 can be configured to estimate the capacity of the location entity based, at least in part, on the occurrence of a “turnaround”. A turnaround can occur, for example, when a user arrives at or within a proximity of a location entity that the user intends to patronize, but leaves without becoming a patron. As one example, a user can visit a restaurant that she intends to patronize, but leave when she realizes that the restaurant is full and/or has an undesirable wait time. The occurrence of a turnaround can indicate that the location entity is at capacity. Thus, capacity estimation system 104 can be configured to determine the occurrence of a turnaround, as further described herein with respect to FIG. 5. Capacity estimation system 104 can determine the number of user devices associated with the location entity during a time period in which a turnaround occurs and can estimate the capacity of the location entity based, at least in part, on that number of user devices.

Capacity estimation system 104 can be configured to provide data indicative of the estimated capacity to the one or more user devices 102. For example, capacity estimation system 104 can provide the data indicative of estimated capacity in response to a request from a user device 102 (e.g., as information provided for a location entity within a mapping application operated by the user) and/or provide the estimated capacity without receiving a request from a user device 102. User device 102 can display a value and/or other character indicated of the estimated capacity via an output device (e.g., display screen) and/or on a user interface.

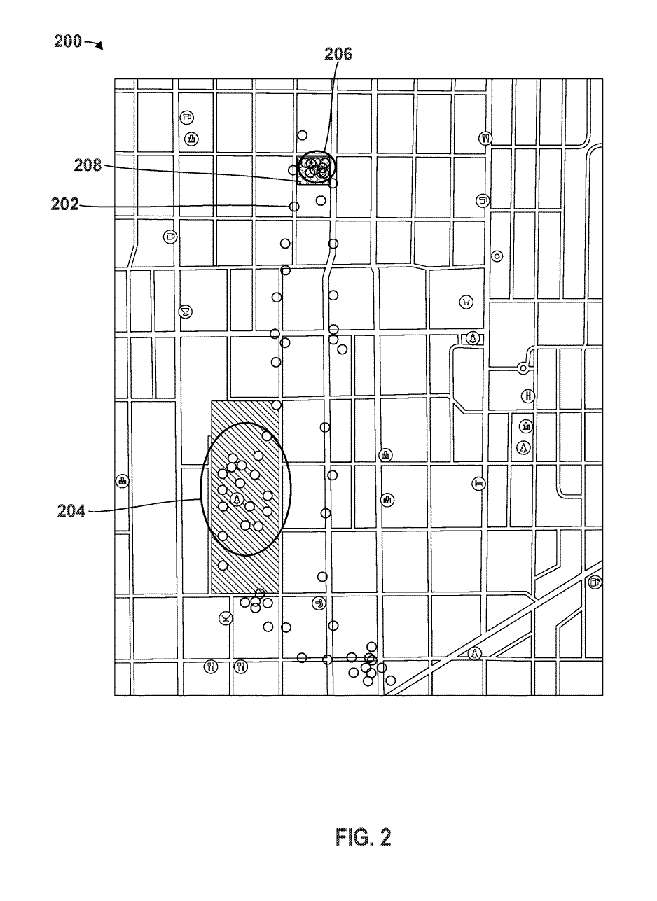

FIG. 2 depicts an example graphical representation 200 of a plurality of location reports according to example embodiments of the present disclosure. In particular, graphical representation 200 depicts a plurality of markers (e.g., marker 202) that respectively correspond to a plurality of locations respectively provided by a plurality of location reports. Thus, each marker corresponds to a location at which a device associated with a user is thought to have been located at a particular time.

As shown in FIG. 2, the plurality of markers can be clustered into a plurality of segments, such as, for example, segments 204 and 206. Each segment can include one or more of the plurality of location reports.

According to an aspect of the present disclosure, in some embodiments, clustering the location reports into a plurality of segments can include a consideration of contextual information regarding the location that the location reports indicate. For example, in some implementations, location entity boundaries, categorizations, or other information can affect the clustering of location reports.

As an example, segment 206 includes a plurality of location reports that indicate the user was associated with restaurant 208. Small gaps between location reports can be merged if, for instance, the inferred activity is the same. Therefore, while the location reports included in segment 206 may not have corresponded to a segment in other circumstances, because they are located within the boundaries of restaurant 208 the location reports can be clustered to form segment 206.

Further, a starting time and ending time can be associated with each segment. For example, the starting time for each segment can be the earliest time associated with any location report included in such segment. Likewise, the ending time for each segment can be the latest time associated with any location report included in such segment. In some implementations, if the ending time of a segment minus the starting time of the segment is not greater than a threshold value (e.g. ten minutes), then such segment can be discarded or otherwise ignored.

FIG. 3 depicts a flow chart of an example method (300) for determining user device location according to example embodiments of the present disclosure. Method (300) can be implemented using any suitable system, including, for example, system 100 of FIG. 1. In addition, although FIG. 3 depicts steps performed in a particular order for purposes of illustration and discussion, the methods discussed herein are not limited to any particular order or arrangement. One skilled in the art, using the disclosures provided herein, will appreciate that various steps of method (300) can be omitted, rearranged, combined, and/or adapted in various ways without deviating from the scope of the present disclosure.

At (302) a plurality of location reports can be obtained. For example, one or more user devices can periodically provide a raw location report to one or more servers and the received reports can be stored. In some implementations, each location report can provide a time and a location. For example, the location included in each location report can be a geocode (e.g. latitude and longitude), IP address information, WiFi location information, or other information identifying or associated with a particular location. At (302) the plurality of location reports can be accessed from memory or otherwise obtained.

At (304) the location reports can be clustered into segments. As an example, at (304) the plurality of location reports obtained at (302) can be clustered based on location or time. Thus, for example, if a number of location reports provide the same general location over a significant period of time, then such reports can be clustered together to form a segment (e.g., segment 206 of FIG. 2).

As another example, in some embodiments, a score can be determined for each of a plurality of candidate segments at (304). For example, the score for each candidate segment can be based on a distance from each location report included in such candidate segment to a mean location associated with the candidate segment. The candidate segments receiving the highest scores can be selected for use by a system implementing the present disclosure.

In some implementations, the score for each candidate segment can equal the summation for all location reports included in such segment of the following equation: (1−[(distance from location report to mean segment location)̂2/k̂2]). Therefore, location reports closer than a distance k will increase the candidate segment score while location reports further than the distance k will decrease the score. The distance k can be a constant value or can be variable based on location context, device velocity, or other parameters.

At (306) the next segment can be considered. In particular, after the location reports are clustered into segments at (304), the segments can be ordered according to any logic (e.g. chronological) and then considered on an individual basis. It will be understood that parallel computing can be used to consider multiple segments at once, as well. Thus, at the first instance of (306), a first segment can be considered, and at subsequent instances of (306), additional segments can be considered.

At (308) a plurality of candidate location entities can be identified for the segment being considered. As an example, map data can be analyzed to identify all location entities that are within a threshold distance from a segment location associated with the segment. For example, the segment location can be a mean location of all location reports included in the segment, a median location of all location reports included in the segment, or the location of any location report included in the segment. Thus, for example, all businesses or other points of interest within a threshold distance (e.g., 1000 ft., 750 ft., 500 ft., 250 ft., 50 ft., etc.) of the mean location can be identified at (308).

At (310) the next location entity can be considered. In particular, after the location entities have been identified at (308), the location entities can be ordered according to any logic and then considered on an individual basis. It will be understood that parallel computing can be used to consider multiple location entities at once, as well. Thus, at the first instance of (310), a first location entity can be considered.

At (312) one or more feature values can be determined for the location entity being considered. More particularly, the one or more feature values determined for each location entity can respectively correspond to one or more features describing information about the location entity being valued.

As an example, the one or more features examined at (312) can be one or more distance features that capture information about how far a location entity is from the segment. Generally, the distance features depend on the segment and the location entity. Some distance features can use information from each location report included in a segment. Other distance features can use only a single segment location derived by aggregating all reports.

For example, one distance feature can describe a distance between the location entity being valued and a segment location associated with the segment for which the location entity was identified. The segment location can be a mean location of all location reports included in the segment, a median location of all location reports included in the segment, or other formulations describing one or more locations associated with the segment.

As another example, another distance feature can describe the distance between the location entity being valued and the segment location divided by the max distance associated with any location entity identified for such segment. As other examples, the distance features can include various forms of scaling, evaluation of the exponential function with respect to various distances, evaluation of a logarithmic function with respect to various distances, or other formulations.

As another example, the one or more features examined at (312) can be one or more popularity feature indicative of a popularity of the location entity being valued with respect to all people. As examples, the popularity features can include (and/or be influenced by) a number of social media mentions associated with the location entity; a number of check-ins associated with the location entity; a number of requests for directions to the location entity; a global popularity rank associated with the location entity; and/or other information that is indicative of the popularity of a location entity. For example, global popularity rankings can be pre-computed for location entities and accessed at (312). As other examples, the popularity features can include various forms of scaling, evaluation of the exponential function with respect to various rankings, evaluation of a logarithmic function with respect to various rankings, or other formulations.

As yet another example, the one or more features associated with the location entity can include a business hour overlap feature. In particular, the business hour overlap feature can describe whether a set of business hours associated with the location entity being valued overlap with a segment time associated with the segment with respect to which the location entity being valued was identified.

As another example, the one or more features associated with the location entity and/or examined at (312) can include one or more personalization features indicative of a user's interest in the location entity. Generally, such features can capture how interested a user may be with respect to a particular location entity given available information about the user's previous web-usage. The personalization features can depend upon the location entity, the segment, and the user.

As an example, the personalization features can include (and/or be influenced by) a number of instances in which the user performed a map click with respect to the location entity; a number of instances in which the user requested directions to the location entity being valued; a number of instances in which the user has checked-in to the location entity; a number of instances in which the user has performed a web search query with respect to the location entity; and/or a rating or review provided by the user for the location entity.

As another example, the personalization features can include (and/or be influenced by) a number of instances in which the user has transacted with the location entity as evidenced by data obtained from a mobile payment system or virtual wallet.

Thus, for example, a location entity with which the user has frequently interacted with in the past can receive larger personalization feature values. Furthermore, in some implementations, the personalization features can further describe or otherwise take into account a temporal correlation between the previous interactions between the user and the location being valued and a segment time associated with the segment for which the location entity being valued was identified. For example, interactions that are closer in time to the segment time can more positively influence feature values than interactions that are more distant in time from the segment time.

Thus, in some embodiments, a user may not receive the benefits or be included in the techniques described herein unless they select a setting and/or install one or more applications, drivers, etc. In some embodiments, certain data can be treated in one or more ways before it is stored or used, so that user information and/or geographic information is removed.

At (314) it can be determined whether additional unconsidered location entities have been identified for the segment being considered. If it is determined at (314) that additional unconsidered location entities exist, then method (300) can return to (310) and consider the next location entity. However, if it is determined at (314) that additional unconsidered location entities do not exist for the segment being considered, then method (300) can proceed to (316).

At (316) each location entity for the segment being considered can be scored based on the feature values respectively determined at (312). In particular, each location entity can be scored according to a scoring formula. For example, the scoring formula can provide a score for each location entity based at least in part on a comparison of the one or more features values associated with the location entity being scored versus the feature values associated with all other location entities identified for the segment of the location entity being scored.

As an example, in some implementations, a scoring formula numerator can equal the exponential function evaluated at a total feature value associated with the location entity being scored. In particular, the total feature value can equal the sum of each feature value associated with the location entity being scored multiplied by one of a plurality of weighting values respectively associated with the features. Likewise, the scoring formula denominator can equal a summation, for all other location entities identified for the segment, of the exponential function respectively evaluated at the total feature value for each of such location entities.

In some implementations, the plurality of weighting values can be identified using computer learning. For example, a computing device can be trained on training data having a known characterization. In particular, the training data can be data obtained from edits to the location histories received from users.

At (318) one of the location entities can be selected as the location at which the user is located. For example, the highest-scoring location entity can be selected at (318). As another example, if the score of the highest-scoring location entity is greater than a threshold value, then the highest-scoring location entity can be selected at (318) for the segment and can be included in the user location history.

FIG. 4 depicts a flow chart of an example method for estimating location entity capacity according to example embodiments of the present disclosure. Method (400) can be implemented using any suitable system, including, for example, system 100 of FIG. 1. In addition, although FIG. 4 depicts steps performed in a particular order for purposes of illustration and discussion, the methods discussed herein are not limited to any particular order or arrangement. One skilled in the art, using the disclosures provided herein, will appreciate that various steps of method (400) can be omitted, rearranged, combined, and/or adapted in various ways without deviating from the scope of the present disclosure.

At (402), method (400) can include obtaining a plurality of location reports from one or more user devices. For instance, capacity estimation system 104 can obtain a plurality of location reports from one or more user devices in a manner similar to that described above with respect to method (300).

At (404), method (400) can include determining whether one or more user devices are associated with a location entity. Capacity estimation system 104 can determine whether one or more user devices are associated with a location entity based, at least in part, on the set of data of the plurality of location reports. For instance, capacity estimation system 104 can cluster the plurality of location reports into segments, identify candidate location entities based, at least in part, on the segments, rank the candidate location entities, and select one of the candidate location entities as the location entity at which the user device is located, as described above with respect to method (300).

At (406), method (400) can include determining a number of user devices associated with the location entity. Capacity estimation system 104 can determine one or more sets of data associated with the location entity at one or more times, wherein each of the values is indicative of at least a number of the one or more user devices associated with the location entity at the respective time. This can be accomplished by, for example, repeatedly performing method (300) for a plurality of user devices at various times. For instance, at various points-in time and/or time periods, the capacity estimation system 104 can determine the number of user devices that are located at restaurant 208 by adding the number of user devices that are determined, through the performance of method (300), to be located at the restaurant 208 at that point-in-time and/or time period.

At (408), method (400) can include estimating the capacity of the location entity. Capacity estimation system 104 can estimate a capacity of the location entity based, at least in part, on the one or more values associated with the location entity at the one or more points-in-time. For example, as indicated above, using method (300), the capacity estimation system 104 can determine that a number of user devices are located at restaurant 208 at various points-in-time. Capacity estimation system 104 can then use the number of user devices located at restaurant 208, at each point-in-time, to estimate capacity. In this way, capacity verification system 104 can use current and/or historical measurements of the number of user devices associated with the location entity in its capacity estimation.

For instance, capacity estimation system 104 can utilize a binomial distribution statistical approach to estimate the capacity of a location entity. For instance, capacity estimation system 104 can determine a number of user devices that are associated with the location entity within one or more time periods. Capacity estimation system 104 can generate one or more parameters of a binomial distribution based at least in part on the number of user devices that are associated with the location entity within each of the one or more time periods. Moreover, capacity estimation system 104 can estimate the capacity of the location entity based at least in part on the one or more parameters of the binomial distribution.

By way of example, based on the location data reports, capacity estimation system 104 can create a sample for a given time period (e.g., hour, day, week, month, etc.) by determining the number of user devices that are located within restaurant 208 over the course of the given time period. Capacity estimation system 104 can create a plurality of samples for a plurality of time periods. Assuming that restaurant 208 reaches capacity during a given time period, capacity estimation system 104 can determine a representative capacity value for each sample based on the number of user devices located at the location entity. For instance, the representative capacity value can be the maximum number of user devices located at the location entity during the given time period. However, other approaches (e.g., based on sample variance, sample mean, method of moments, etc.) can be used to determine the representative capacity value for each sample.

Capacity estimation system 104 can create a data set that includes the representative capacity values for each of the plurality of samples. Capacity estimation system 104 can then fit a binomial distribution to the data set by varying the distribution parameters. In some implementations, the n parameter of the binomial distribution can represent an estimated capacity for the location entity and the p parameter can represent a probability that an individual located within the location entity is associated with a user device that sends location reports to capacity estimation system 104. Capacity estimation system 104 can estimate the capacity of the location entity by identifying a binomial distribution which best fits the data set and its estimated capacity (e.g., n parameter).

In another example, capacity estimation system 104 can utilize one or more Markov models to estimate the capacity of a location entity. For instance, capacity estimation system 104 can utilize a continuous time Markov chain model to estimate the capacity of a location entity. Capacity estimation system 104 can determine input data for the continuous time Markov chain from the location data reports. The input data can include, for example, a number and/or rate of user devices that arrive at a location entity, a number and/or rate of user devices that depart a location entity, and/or a number and/or rate of user devices that turned-around before entering the location entity (as described in greater detail with respect to FIG. 5) within a time period. Additionally, and/or alternatively, capacity estimation system 104 can use one or more model parameters. The model parameters can include, for example, a percentage of user devices within the location entity that are sending location reports, the length of time a user device remains at the location entity, the total number of user devices at the location entity, a capacity estimation, etc. Capacity estimation system 104 can utilize the input data to find the model parameters for which the resulting continuous time Markov chain best fits the collected data. Capacity estimation system 104 can then estimate the capacity for a location entity based, at least in part, on the best fitting statistical distribution.

In other example embodiments, capacity estimation system 104 can use a maximum likelihood estimation statistical approach. Capacity estimation system 104 can determine the number of user devices associated with a location entity within each of a plurality of time periods. For example, each of the time periods can be a day, and capacity estimation system 104 can determine the number of user devices located at restaurant 208 during the same one or more time periods for each day. Capacity estimation system 104 can generate a set of data indicative of the number of user devices associated with the location entity (e.g., restaurant 208) within each of the plurality of time periods. Capacity estimation system 104 can then estimate the capacity of the location entity (e.g., restaurant 208) using the following example statistical approach.

Capacity estimation system can generate a statistical distribution D that represents the number of individuals that desire to be associated with the location entity (e.g., desire to be located at restaurant 208) within each time period. The statistical distribution D can be a statistical distribution over non-negative integers. For example, in some implementations, D can be a discrete power law distribution, Poisson distribution, etc.

The distribution D can include one or more parameters. For instance, capacity estimation system 104 can include one or more parameters in distribution D that represent the capacity of the location entity (e.g., restaurant 208). In some implementations, a parameter m can be added and distribution D can modified to produce a new distribution E, which can represent the number of user devices associated with the location entity conditioned on a number of individuals actually associated with the location entity (e.g., individuals that successfully entered restaurant 208). For example, if D produces a value less than or equal to m, E can produce that same value. But if D produces a value greater than m, E can instead produce m. In this example, when the number of individuals who want to enter restaurant 208 is greater than m, only m people are successful.

Capacity estimation system 104 can then create a statistical distribution F, that represents the number of individuals associated with the location entity. Statistical distribution F can include parameters n and p. The n parameter can, for example, be a sample x from the distribution E. Thep parameter can, for example, represent the probability that an individual associated with the location entity (e.g., located at restaurant 208) is associated with a user device that sends location reports to capacity estimation system 104. Capacity estimation system 104 can then create a binomial distribution, with parameters n and p.

Thus, using the above-described approach, capacity estimation system 104 can create a distribution F that can include parameters n and p, one or more parameters of distribution D (e.g., including a capacity of the location entity), and/or one or more parameters of distribution E. Capacity estimation system 104 can utilize the maximum likelihood approach to find the values of all these parameters that result in the best fit of distribution F to the number of user devices associated with the location entity (e.g., restaurant 208) within each of the plurality of time periods. Capacity estimation system 104 can then estimate the capacity of the location entity based on the best fit of distribution F.

Additionally, and/or alternatively, capacity estimation system 104 can determine an occurrence of a turnaround based, at least in part, on the plurality of location reports. Capacity estimation system 104 can estimate the capacity of the location entity based, at least in part, on the occurrence of the turnaround. For instance, capacity estimation system 104 can determine the number of user devices associated with the location entity (e.g., located at the location entity) during a time period in which a turnaround occurred and can estimate the capacity of the location entity based, at least in part, on that number of user devices.

FIG. 5 depicts a flow chart of an example method for determining the occurrence of a turnaround according to example embodiments of the present disclosure. Method (500) can be implemented using any suitable system, including, for example, system 100 of FIG. 1. In addition, although FIG. 5 depicts steps performed in a particular order for purposes of illustration and discussion, the methods discussed herein are not limited to any particular order or arrangement. One skilled in the art, using the disclosures provided herein, will appreciate that various steps of method (500) can be omitted, rearranged, combined, and/or adapted in various ways without deviating from the scope of the present disclosure.

At (502), method (500) can include determining one or more features associated with a location entity. For instance, capacity estimation system 104 can determine that a user associated with user device 102 intended to patronize a location entity based, at least in part, on the one or more features associated with the location entity. As indicated above, the one or more features associated with a location entity can describe information about the location entity, such as an interest level associated with the location entity. The one or more features can include a popularity feature indicative of a popularity of the location entity and/or a personalization feature indicative of the user's personal interest in the location entity. For example, capacity estimation system 104 can determine that a user intends to go to a concert hall based on the number of times the user has performed a map-click and/or requested directions for that concert hall.

At (504), method (500) can include receiving a first location report that includes a first set of data indicative of a first location and a first time associated with user device. At (506), method (500) can include receiving a second location report that includes a second set of data indicative of a second location and a second time associated with user device. For instance, capacity estimation system 104 can receive the first and second location reports. The first location (of the first location report) can, for example, indicate that a user device is within a proximity of the location entity (e.g., the concert hall the user intended to patronize). The second location (of the second location report) can, for example, indicate that a user device is not within a proximity of the location entity (e.g., the concert hall).

At (508), method (500) can include determining the occurrence of a turnaround based, at least in part, on the one or more features, the first location report, and/or the second location report. For instance, capacity estimation system 104 can determine the occurrence of a turnaround based, at least in part, on the first location report, the second location report, and/or the one or more features.

Capacity estimation system 104 can determine that the user associated with the user device intended to patronize the location entity based on one or more features associated with the location entity (e.g., a user device has requested directions to the location entity several times). Capacity estimation system 104 can determine that user device is within a proximity (e.g., certain distance radius, similar region, similar area, similar block, same street) of the location entity based at least in part on the first location included in the first location report. Capacity estimation system 104 can then determine that user device has left the proximity of the location entity based at least in part on the second location, which can be different than the first location. Capacity estimation system 104 can determine a time difference between the first time (associated with the first location) and the second time (associated with the second location) and compare the time difference to a time threshold. The time threshold can, for example, represent the average minimum time a patron typically spends at the location entity, a typical time for attending an event at the location (e.g., concert, sporting event, play, etc.), or other times associated with typical patrons of the location entity. The systems and methods can determine the occurrence of a turnaround based, at least in part, on the time difference being less than the time threshold.

By way of example, capacity estimation system 104 can determine that a user intends to attend a concert hall based on, for instance, the number of times the user requests directions to the concert hall on her user device. Capacity estimation system 104 can receive a first location report indicating that the user device associated with the user is within the same block as the concert hall and a first time. Capacity estimation system 104 can receive a second location report indicating that the user device is no longer within the same block as the concert hall (e.g., that the user has left the proximity of the concert hall) and a second time. To determine that the user did not, in fact, patronize the concert hall, capacity estimation system 104 can determine a time difference between the first and second times and compare the time difference to a time threshold, such as an average minimum time for a concert at the concert hall. If the time difference is less than the time threshold, capacity estimation system 104 can infer that the user did not patronize the concert hall, which may be due to the concert hall being at capacity. Thus, capacity estimation system 104 can determine a number of user devices located at the concert hall between the first time and the second time. Capacity estimation system 104 can estimate the capacity of the concert hall based, at least in part, on the determined number of user devices located at the concert hall between the first time and the second time. For instance, capacity estimation system 104 can consider this number when performing a statistical approach, as described herein.

In some embodiments, capacity estimation system 104 can determine the occurrence of a turnaround based on the location of a user device and a user's potential interest in an alternative location. For instance, capacity estimation system 104 can determine that a user device is within a proximity of the location entity based, at least in part, on the first location (included in the first location report). Capacity estimation system 104 can determine one or more features associated with an alternative location entity, where the features associated with the alternative location entity indicate an interest level associated with the alternative location entity. The features associated with the alternative location can include, for example, a number of instances in which the user has performed a web search query with respect to the alternative location entity number of instances in which the user performed a map click with respect to the alternative location entity; a number of instances in which the user requested directions to the alternative location entity; a number of instances in which the user has checked-in to the alternative location entity; a number of instances in which the user has performed a web search query with respect to the alternative location entity; a rating or review provided by the user for the alternative location entity; and/or other features as previously described above.

Capacity estimation system 104 can determine that the first user device is not within a proximity of the location entity based at least in part on the second location. Capacity estimation system 104 can determine the occurrence of a turnaround based, at least in part, on the features associated with the alternative location entity (indicating the user's interest in the alternative location entity) and the second location included in the second location report (indicating that the user has left the proximity of the location entity).

For example, capacity estimation system 104 can determine that a user intends to patronize a restaurant based, at least in part on, a number of instances in which the user has performed a web search query regarding the menu of the restaurant. Capacity estimation system 104 can receive a first location report indicating that a user device associated with the user is within the same block as the restaurant and a first time. Capacity estimation system 104 can determine that the user may have an interest level associated with an alternative restaurant based on, for example, the user requesting directions to another restaurant. Capacity estimation system 104 can receive a second location report indicating that the user device is no longer within the same block as the restaurant and a second time. Capacity estimation system 104 can determine a turnaround has occurred based on the user's interest in an alternative restaurant and the second location report indicating that the user has left the proximity of the restaurant. The user may have left due to the restaurant being at capacity. Thus, capacity estimation system 104 can estimate the capacity of the restaurant based, at least in part, on a number of user devices located at the restaurant during the time period associated with the turnaround (e.g., between the first time and the second time).

In some implementations, a turnaround can be particularly indicated when the alternative location entity is of a similar character to the original location entity. For example, if the user searches for an alternative breakfast restaurant after arriving at the original breakfast restaurant, this can be viewed as a more significant indicator of a turnaround than if the user searched for an outdoor sports equipment shop after arriving at the original breakfast restaurant. Thus, in some implementations, a degree of relatedness or fungibility between the original and alternative location entities can impact the detection of a turnaround. In some implementations, capacity estimation system 104 can determine an occurrence of a turnaround based, at least in part, on both the comparison of a time difference to a time threshold and a user's interest in an alternative location.

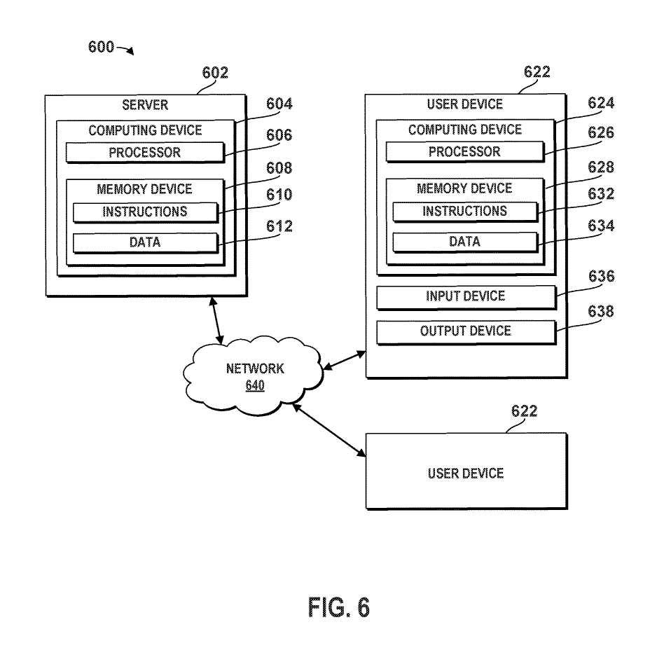

FIG. 6 depicts a computing system 600 that can be used to implement the methods and systems for determining the capacity of a location entity according to example embodiments of the present disclosure. The system 600 can be implemented using a client-server architecture that includes a server 602 and one or more user devices 622 which act as clients of the server 602. Server 602 can correspond to the capacity server, as described herein. Server 602 can correspond, for example, to a web server hosting a geographic information system. User device 622 can correspond, for example, to a user device, as described herein, and/or a personal communication device, a smartphone, navigation system, laptop, mobile device, tablet, wearable computing device or the like.

Each of the server 602 and user device 622 can include at least one computing device, such as depicted by server computing device 604 and user computing device 624. Although only one server computing device 604 and one user computing device 624 are illustrated in FIG. 6, multiple computing devices optionally can be provided at one or more locations for operation in sequential configurations or parallel configurations to implement the disclosed methods and systems of determining location entity capacity. In other examples, the system 600 can be implemented using other suitable architectures, such as a single computing device.

Each of the computing devices 604, 624 in system 600 can be any suitable type of computing device. For example computing devices 604, 624 can include a general purpose computer, special purpose computer, and/or other suitable computing device. Computing device 624 can include, for instance, a navigation system, GPS, and/or other suitable device.

The computing devices 604 and/or 624 can respectively include one or more processor(s) 606, 626 and one or more memory devices 608, 628. The one or more processor(s) 606, 626 can include any suitable processing device, such as a microprocessor, microcontroller, integrated circuit, logic device, one or more central processing units (CPUs), graphics processing units (GPUs) dedicated to efficiently rendering images or performing other specialized calculations, and/or other processing devices. The one or more memory devices 608, 628 can include one or more computer-readable media, including, but not limited to, non-transitory computer-readable media, RAM, ROM, hard drives, flash drives, or other memory devices. In some examples, memory devices 608, 628 can correspond to coordinated databases that are split over multiple locations.

The one or more memory devices 608, 628 can store information accessible by the one or more processors 606, 626, including instructions 610, 634 that can be executed by the one or more processors 606, 626. For instance, server memory device 608 can store instructions for implementing a capacity determination algorithm configured to perform various functions disclosed herein. The user memory device 628 can store instructions for implementing a browser that allows a user to request information from server 602, including estimated capacity values of location entities.

The one or more memory devices 608, 628 can also include data 612, 632 that can be retrieved, manipulated, created, or stored by the one or more processors 606, 626. The data 612 stored at server 602 can include, for instance, the collection of location data reports that are analyzed in method (200), databases of location entities, and the resultant data structures and clustering outputs determined in accordance with the disclosed techniques. The data 632 stored at client 622 can include, for example, current location reports.

Computing devices 604 and 624 can communicate with one another over a network 640. In such instances, the server 602 and one or more clients 622 can also respectively include a network interface used to communicate with one another over network 640. The network interface(s) can include any suitable components for interfacing with one more networks, including for example, transmitters, receivers, ports, controllers, antennas, or other suitable components. The network 640 can be any type of communications network, such as a local area network (e.g. intranet), wide area network (e.g. Internet), cellular network, or some combination thereof. The network 640 can also include a direct connection between server computing device 604 and user computing device 624. In general, communication between the server computing device 604 and user computing device 624 can be carried via network interface using any type of wired and/or wireless connection, using a variety of communication protocols (e.g. TCP/IP, HTTP, SMTP, FTP), encodings or formats (e.g. HTML, XML), and/or protection schemes (e.g. VPN, secure HTTP, SSL).

Computing device 604 can analyze data associated with various online services to identify any interactions between a particular user and a particular location entity. As an example, computing device 604 can analyze search data, map data, email data, social media data, or other suitable forms of data to extract one or more interactions. Such data can be stored within data 612, data 632, and/or one or more separate databases that can be accessed via network 640. For instance, an interaction evidenced by search data can include a search query inputted by a user that references a particular location entity. As another example, an interaction evidenced by map data can include a request for directions to a particular location entity or a selection of an icon representing the particular location entity within a mapping application. As yet another example, an interaction evidenced by email data can include flight or hotel reservations to a particular city or lodging or reservations for dinner at a particular restaurant. As another example, an interaction evidenced by social media data can include a check-in, a like, a comment, a follow, a review, or other social media action performed by the user with respect to a particular location entity.

User device 622 can include various input/output devices for providing and receiving information to/from a user. For instance, an input device 636 can include devices such as a touch screen, touch pad, data entry keys, and/or a microphone suitable for voice recognition. An output device 638 can include audio or visual outputs such as speakers or displays for indicating, for instance, capacity estimates of location entities. Audio and/or visual alarms could also be provided at output device 638 to provide signals to a user indicating the arrival of a user at certain location entities and/or the capacity of a location entity.

Thus, the systems and methods of the present disclosure can be implemented to estimate the capacity of a location entity based, at least in part, on location reports associated with a user device.

The technology discussed herein makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, server processes discussed herein can be implemented using a single server or multiple servers working in combination. Databases and applications can be implemented on a single system or distributed across multiple systems. Distributed components can operate sequentially or in parallel.

Furthermore, computing tasks discussed herein as being performed at a server can instead be performed at a user device. Likewise, computing tasks discussed herein as being performed at the user device can instead be performed at the server.

While the present subject matter has been described in detail with respect to specific example embodiments and methods thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computer-implemented method of ascertaining capacities of location entities, the method comprising:
obtaining, by one or more computing devices, a plurality of location reports from one or more user devices, wherein each of the plurality of location reports includes at least a set of data indicative of an associated location and time;
determining, by the one or more computing devices, whether the one or more user devices are associated with a location entity based at least in part on the set of data of the plurality of location reports;
determining, by the one or more computing devices, one or more sets of data associated with the location entity at one or more times, wherein each of the sets of data is indicative of at least a number of the one or more user devices associated with the location entity at the respective time; and
estimating, by the one or more computing devices, a capacity of the location entity based at least in part on the one or more sets of data associated with the location entity at the one or more times.

2. The computer-implemented method of claim 1, wherein estimating, by the one or more computing devices, the capacity of the location entity comprises:
generating, by the one or more computing devices, one or more parameters of a binomial distribution based at least in part on the one or more sets of data associated with the location entity at the one or more times; and
estimating, by the one or more computing devices, the capacity of the location entity based at least in part on the one or more parameters of the binomial distribution.

3. The computer-implemented method of claim 1, wherein estimating, by the one or more computing devices, the capacity of the location entity comprises:
utilizing, by the one or more computing devices, a continuous time Markov chain model to estimate the capacity of the location entity.

4. The computer-implemented method of claim 1, wherein estimating, by the one or more computing devices, the capacity of the location entity comprises:
generating, by the one or more computing devices, a first statistical distribution to represent a number of individuals that desire to be associated with the location entity;
generating, by the one or more computing devices, a second statistical distribution, wherein the second statistical distribution represents the number of user devices associated with the location entity conditioned on a number of individuals actually associated with the location entity; and
generating, by the one or more computing devices, a third statistical distribution, wherein the third statistical distribution represents a number of individuals associated with the location entity, based at least in part on one or more parameters of the first statistical distribution, one or more parameters of the second distribution, and a capacity of the location entity.

5. The computer-implemented method of claim 1, wherein the capacity is the maximum number of individuals that are allowed to patronize the location entity.

6. The computer-implemented method of claim 1, wherein:
the one or more user devices includes a first user device associated with a user; and
the plurality of location reports includes a first location report and a second location report, the first location report comprising a first set of data indicative of a first location and a first time associated with the first user device, the second location report comprising a second set of data indicative of a second location and a second time associated with the first user device.

7. The computer-implemented method of claim 6, wherein estimating, by the one or more computing devices, the capacity of the location entity comprises:
determining, by the one or more computing devices, an occurrence of a turnaround based at least in part on the first location report and the second location report; and
estimating, by the one or more computing devices, the capacity of the location entity based at least in part on the occurrence of the turnaround.

8. The computer-implemented method of claim 7, wherein determining, by the one or more computing devices, the occurrence of the turnaround comprises:
determining, by the one or more computing devices, that the user associated with the user device intended to patronize the location entity based on one or more features associated with the location entity, wherein the one or more features describe information about the location entity.

9. The computer-implemented method of claim 8, wherein the one or more features indicate an interest level associated with the location entity.

10. The computer-implemented method of claim 8, wherein:
the one or more features comprise one or more of a feature indicative of a popularity of the location entity or a feature indicative of the user's interest in the location entity;
the feature indicative of a popularity of the location entity comprises one or more of a number of social media mentions associated with the location entity, a number of check-ins associated with the location entity, or a number of requests for directions to the location entity; and
the feature indicative of the user's interest in the location entity comprises a number of instances in which the user performed a map click with respect to the location entity, a number of instances in which the user requested directions to the location entity, a number of instances in which the user has previously checked-in to the location entity, or a number of instances in which the user has performed a web search query with respect to the location entity.

11. The computer-implemented method of claim 7, wherein determining, by the one or more computing devices, an occurrence of a turnaround based at least in part on the first location report and the second location report comprises:
determining, by the one or more computing devices, that the first user device is within a proximity of the location entity based at least in part on the first location;
determining, by the one or more computing devices, that the first user device is not within a proximity of the location entity based at least in part on the second location, wherein the second location is different from the first location;
determining, by the one or more computing devices, a time difference between the first time associated with the first location and the second time associated with the second location;
comparing, by the one or more computing devices, the time difference between the first time and the second time to a time threshold; and
determining, by the one or more computing devices, the occurrence of the turnaround based at least in part on the time difference between the first time and the second time being less than the time threshold.

12. The computer-implemented method of claim 7, wherein determining, by the one or more computing devices, an occurrence of a turnaround based at least in part on the first location report and the second location report comprises:
determining, by the one or more computing devices, that the first user device is within a proximity of the location entity based at least in part on the first location;
determining, by the one or more computing devices, one or more features associated with an alternative location entity, wherein the one or more features associated with the alternative location entity indicate an interest level associated with the alternative location entity; and
determining, by the one or more computing devices, that the first user device is not within a proximity of the location entity based at least in part on the second location.

13. A computing system, comprising:
one or more processors; and
one or more memory devices, the one or more memory devices storing computer-readable instructions that when executed by the one or more processors, cause the one or more processors to perform operations, the operations comprising:
obtaining a plurality of location reports from one or more user devices, wherein each of the plurality of location reports indicates an associated location and time;
determining whether the one or more user devices are associated with a location entity based at least in part on the plurality of location reports; and
estimating a capacity of the location entity based at least in part on a number of the one or more user devices associated with the location entity.

14. The system of claim 13, wherein estimating the capacity of the location entity based at least in part on the number of the one or more user devices associated with the location entity comprises:
generating one or more parameters of a binomial distribution based on the number of user devices that are associated with the location entity within one or more time periods; and
estimating the capacity of the location entity based on the one or more parameters of the binomial distribution.

15. The system of claim 13, wherein estimating the capacity of the location entity based at least in part on the number of the one or more user devices associated with the location entity comprises:
utilizing a continuous time Markov chain model to estimate the capacity of the location entity.

16. The system of claim 13, wherein estimating the capacity of the location entity based at least in part on the number of the one or more user devices associated with the location entity comprises:
generating, by the one or more computing devices, a first statistical distribution to represent a number of individuals that desire to be associated with the location entity;
generating, by the one or more computing devices, a second statistical distribution, wherein the second statistical distribution represents the number of user devices associated with the location entity conditioned on a number of individuals actually associated with the location entity; and
generating, by the one or more computing devices, a third statistical distribution, wherein the third statistical distribution represents a number of individuals associated with the location entity, based at least in part on one or more parameters of the first statistical distribution, one or more parameters of the second distribution, and a capacity of the location entity.

17. The system of claim 13, wherein estimating the capacity of the location entity based at least in part on the number of the one or more user devices associated with the location entity comprises:
determining an occurrence of a turnaround and a time period associated with the turnaround based at least in part on the plurality of location reports;
determining a number of the one or more user devices associated with the location entity during the time period associated with the turnaround; and
estimating the capacity of the location entity based at least in part on the number of the one or more user devices associated with the location entity during the time period associated with the turnaround.

18. A computing system, comprising:
one or more processors; and
one or more memory devices, the one or more memory devices storing computer-readable instructions that when executed by the one or more processors, cause the one or more processors to perform operations, the operations comprising:
obtaining a plurality of location reports respectively indicating a location and a time, the plurality of location reports being associated with a plurality of user devices;
determining a location entity associated with the location indicated in each of the plurality of location reports;
determining a number of the plurality of user devices that are located at the location entity within one or more time periods;
estimating a capacity of the location entity based at least in part on the number of the plurality of user devices that are determined to be located at the location entity within the one or more time periods.

19. The system of claim 18, wherein estimating the capacity of the location entity based at least in part on the number of the plurality of user devices that are determined to be located at the location entity within the time period comprises:
utilizing one or more of a binomial distribution, a Markov model, or maximum likelihood estimation to estimate the capacity of the location entity.

20. The system of claim 18, wherein estimating the capacity of the location entity based at least in part on the number of the plurality of user devices that are determined to be located at the location entity within the time period comprises:
determining, by the one or more computing devices, one or more features associated with the location entity, wherein the one or more features indicate an interest level associated with the location entity;
determining, by the one or more computing devices, an occurrence of a turnaround based at least in part on the one or more features associated with the location entity and at least a subset of the plurality of location reports; and
estimating, by the one or more computing devices, the capacity of the location entity based at least in part on the occurrence of the turnaround.
